(19) United States
(12) Patent Application Publication
(10) Pub. No.: US 2023/0327952 A1
(43) Pub. Date: Oct. 12, 2023

(54) Restoring Network Configurations Using Network Topology Snapshots

(71) Applicant: AT&T Intellectual Property I, L.P., Atlanta, GA (US)

(72) Inventors: William E. Reehil, III, Jackson, NJ (US); Robby Maharajh, Malverne, NY (US); Harish Venkata Kajur, Piscataway, NJ (US)

(73) Assignee: AT&T Intellectual Property I, L.P., Atlanta, GA (US)

(21) Appl. No.: 17/714,245

(22) Filed: Apr. 6, 2022

(51) Int. Cl. H04L 41/0859; H04L 41/0853; H04L 41/12

(52) U.S. Cl. CPC H04L 41/0863; H04L 41/0856; H04L 41/12

(57) ABSTRACT

Restoring network configurations using network topology snapshots can include obtaining a first network topology snapshot that describes a first configuration of a network environment at a first point in time, obtaining a second network topology snapshot that describes a second configuration of the network environment at a second point in time, calculating a difference between the first network topology snapshot and the second network topology snapshot, presenting the difference for display, in response to determining that a request to restore a previous configuration has been received, identifying a configuration change that is to be reverted and a restore point associated with the configuration change to be reverted, and outputting a command that, when executed by an orchestration service, causes the orchestration service to revert the configuration change.

### BACKGROUND

When changes are made in a network, effects of that change may impact a wide range of devices and/or entities on the network. Thus, when a change is made to a particular device or software, expected issues and/or unexpected issues may arise in other parts of the network due to the interacting nature of systems and devices in networking environments. In some cases, effects from such impacts can include, for example, loss of service, failed orders, flow fallout, and/or many other issues. There may not be any way to quickly recover from network-topology-induced faults.

Rolling back all network topology changes to some previous point in time may address the network-topology-induced fault being addressed, but may result in other impacts as a result. Namely, network changes may be made to accommodate new equipment, to address known problems, etc., so restoring a network to some previous state of operations may resurface old problems and/or faults that were addressed previously.

### SUMMARY

The present disclosure is directed to restoring network configurations using network topology snapshots. A network environment can be monitored by one or more network monitoring devices such as the network monitor. The network monitor can capture one or more network topology snapshots that define and/or describe a topology and/or configuration associated with the network environment at a particular time. According to various embodiments of the concepts and technologies disclosed herein, the network monitor can be configured to capture the network topology snapshots each time a configuration and/or topology associated with the network environment is changed, thereby capturing entities included in the topology of the network environment; one or more connections between the entities; one or more attributes associated with the entities and/or connections; other attributes; combinations thereof; or the like. The network monitor can release the network topology snapshots to the server computer and/or make the network topology snapshots available to one or more requestors such as, for example, the server computer.

The server computer can store copies of the network topology snapshots and/or access and/or use the network topology snapshots to provide functionality as illustrated and described herein for restoring network configurations using the network topology snapshots. According to various embodiments of the concepts and technologies disclosed herein, the server computer can host and/or execute a network management service that can be accessed via a portal, an application programming interface (“API”), or other functionality by a device such as, for example, the computing device. It should be understood that this example is illustrative, and therefore should not be construed as being limiting in any way.

Via exchanges of session data between the computing device and the server computer, the user and/or other entity associated with the computing device can submit requests to the server computer; the server computer can receive the requests from the computing device; the server computer can send user interface (“UP”) data to the computing device; the computing device can receive the UI data from the server computer; the server computer can send calculated differences to the computing device; the computing device can receive the calculated differences from the server computer; the computing device can submit one or more selections (or data that describe the selections) to the server computer; the server computer can receive the selections from the computing device; and the devices can exchange other data. By way of the session data, the computing device can indicate one or more configurations to restore at the network environment.

The server computer (e.g., via execution of the network management service) can identify the attributes, entities, and/or connections (configurations) associated with the network environment that are to be restored and generate one or more commands for implementing the restoration of those attributes, entities, and/or connections. The server computer (e.g., via execution of the network management service) can send the commands to an orchestration service or other entity that can implement the configuration restoration at the network environment. As such, a user or other entity can selectively restore network configurations using network topology snapshots.

According to one aspect of the concepts and technologies disclosed herein, a system is disclosed. The system can include a processor and a memory. The memory can store computer-executable instructions that, when executed by the processor, cause the processor to perform operations. The operations can include obtaining a first network topology snapshot that describes a first configuration of a network environment at a first point in time, obtaining a second network topology snapshot that describes a second configuration of the network environment at a second point in time, calculating a difference between the first network topology snapshot and the second network topology snapshot, presenting the difference for display at a computing device, in response to determining that a request to restore a previous configuration has been received from the computing device, identifying a configuration change that is to be reverted, and identifying a restore point associated with the configuration change to be reverted. The restore point can include the first point in time. The operations further can include outputting a command that, when executed by an orchestration service, causes the orchestration service to revert the configuration change.

In some embodiments, the second point in time can include a current time and the first point in time can include a time before the second point in time. In some embodiments, the network topology snapshots can be obtained in response to receiving a request to compare the network topology snapshots, and the request can be received from a computing device. In some embodiments, the request can be received via a portal exposed by a server computer. In some embodiments, outputting the command can include generating the command. In some embodiments, operations further can include obtaining an updated network topology snapshot and storing the updated network topology snapshot. The updated network topology snapshot can identify the configuration change that was reverted. In some embodiments, the configuration change can include an attribute change applied to an entity, and the entity can include a physical network function associated with the network environment.

According to another aspect of the concepts and technologies disclosed herein, a method is disclosed. The method can include obtaining, at a server computer including a processor, a first network topology snapshot that describes a first configuration of a network environment at a first point in time; obtaining, by the server computer, a second network topology snapshot that describes a second configuration of the network environment at a second point in time; calculating, by the server computer, a difference between the first network topology snapshot and the second network topology snapshot; presenting, by the server computer, the difference for display at a computing device; in response to determining that a request to restore a previous configuration has been received from the computing device, identifying, by the server computer, a configuration change that is to be reverted; identifying, by the server computer, a restore point associated with the configuration change to be reverted, the restore point including the first point in time; and outputting, by the server computer, a command that, when executed by an orchestration service, causes the orchestration service to revert the configuration change.

In some embodiments, the second point in time can include a current time, and the first point in time can include a time before the second point in time. In some embodiments, the network topology snapshots can be obtained in response to receiving a request to compare the network topology snapshots, and the request can be received from a computing device via a portal exposed by the server computer. In some embodiments, outputting the command can include generating the command. In some embodiments, the method further can include obtaining an updated network topology snapshot and storing the updated network topology snapshot. The updated network topology snapshot can identify the configuration change that was reverted. In some embodiments, the configuration change can include an attribute change applied to an entity, and the entity can include a physical network function associated with the network environment.

According to yet another aspect of the concepts and technologies disclosed herein, a computer storage medium is disclosed. The computer storage medium can store computer-executable instructions that, when executed by a processor, cause the processor to perform operations. The operations can include obtaining a first network topology snapshot that describes a first configuration of a network environment at a first point in time, obtaining a second network topology snapshot that describes a second configuration of the network environment at a second point in time, calculating a difference between the first network topology snapshot and the second network topology snapshot, presenting the difference for display at a computing device, in response to determining that a request to restore a previous configuration has been received from the computing device, identifying a configuration change that is to be reverted, and identifying a restore point associated with the configuration change to be reverted. The restore point can include the first point in time. The operations further can include outputting a command that, when executed by an orchestration service, causes the orchestration service to revert the configuration change.

In some embodiments, the second point in time can include a current time and the first point in time can include a time before the second point in time. In some embodiments, the network topology snapshots can be obtained in response to receiving a request to compare the network topology snapshots, and the request can be received from a computing device. In some embodiments, the request can be received via a portal exposed by a server computer. In some embodiments, outputting the command can include generating the command. In some embodiments, operations further can include obtaining an updated network topology snapshot and storing the updated network topology snapshot. The updated network topology snapshot can identify the configuration change that was reverted. In some embodiments, the configuration change can include an attribute change applied to an entity, and the entity can include a physical network function associated with the network environment. In some embodiments, the network topology snapshot can include data describing an entity, time data, attributes associated with the entity, and a connection associated with the entity.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for restoring a network configuration using network topology snapshots, according to an illustrative embodiment of the concepts and technologies described herein.

FIG. 3 is a flow diagram showing aspects of a method for restoring a network configuration using network topology snapshots, according to an illustrative embodiment of the concepts and technologies described herein.

FIGS. 4A-4C are user interface diagrams showing various screen displays for restoring network configurations using network topology snapshots, according to some illustrative embodiments of the concepts and technologies described herein.

FIG. 5 schematically illustrates a network, according to an illustrative embodiment of the concepts and technologies described herein.

FIG. 6 is a block diagram illustrating an example computer system configured to enable restoring network configurations using network topology snapshots, according to some illustrative embodiments of the concepts and technologies described herein.

FIG. 7 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to restoring network configurations using network topology snapshots. A network environment can be monitored by one or more network monitoring devices such as the network monitor. The network monitor can capture one or more network topology snapshots that define and/or describe a topology and/or configuration associated with the network environment at a particular time. According to various embodiments of the concepts and technologies disclosed herein, the network monitor can be configured to capture the network topology snapshots each time a configuration and/or topology associated with the network environment is changed, thereby capturing entities included in the topology of the network environment; one or more connections between the entities; one or more attributes associated with the entities and/or connections; other attributes; combinations thereof; or the like. The network monitor can release the network topology snapshots to the server computer and/or make the network topology snapshots available to one or more requestors such as, for example, the server computer.

The server computer can store copies of the network topology snapshots and/or access and/or use the network topology snapshots to provide functionality as illustrated and described herein for restoring network configurations using the network topology snapshots. According to various embodiments of the concepts and technologies disclosed herein, the server computer can host and/or execute a network management service that can be accessed via a portal, API, or other functionality by a device such as, for example, the computing device. It should be understood that this example is illustrative, and therefore should not be construed as being limiting in any way.

Via exchanges of session data between the computing device and the server computer, the user and/or other entity associated with the computing device can submit requests to the server computer; the server computer can receive the requests from the computing device; the server computer can send UI data to the computing device; the computing device can receive the UI data from the server computer; the server computer can send calculated differences to the computing device; the computing device can receive the calculated differences from the server computer; the computing device can submit one or more selections (or data that describe the selections) to the server computer; the server computer can receive the selections from the computing device; and the devices can exchange other data. By way of the session data, the computing device can indicate one or more configurations to restore at the network environment.

The server computer (e.g., via execution of the network management service) can identify the attributes, entities, and/or connections (configurations) associated with the network environment that are to be restored and generate one or more commands for implementing the restoration of those attributes, entities, and/or connections. The server computer (e.g., via execution of the network management service) can send the commands to an orchestration service or other entity that can implement the configuration restoration at the network environment. As such, a user or other entity can selectively restore network configurations using network topology snapshots.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

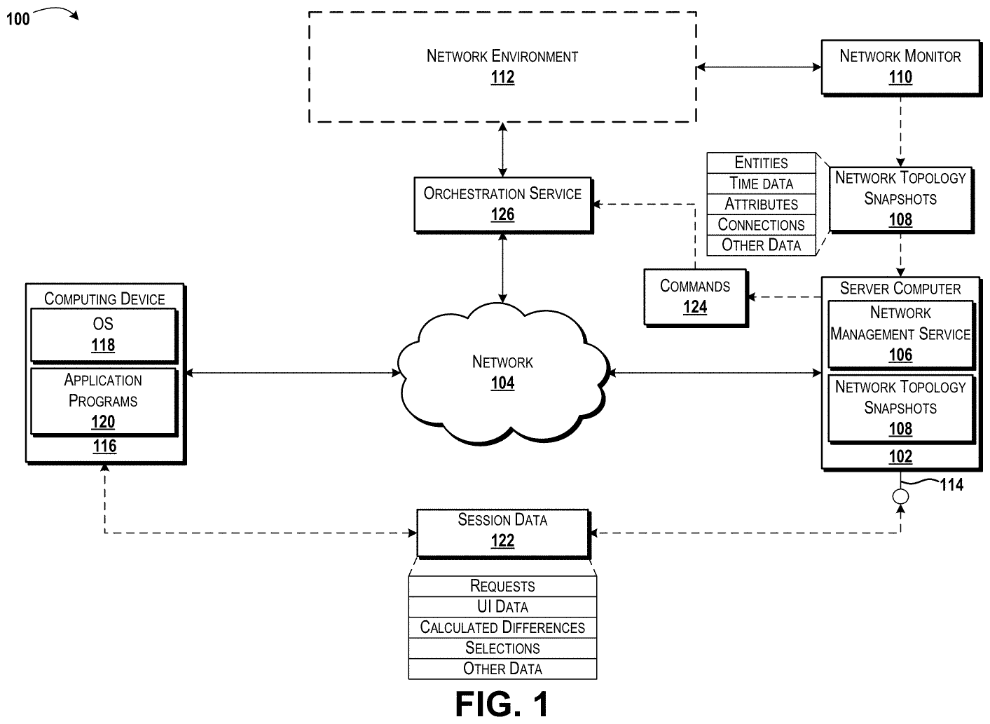

Referring now to FIG. 1, aspects of an operating environment 100 for various embodiments of the concepts and technologies disclosed herein for restoring network configurations using network topology snapshots will be described, according to an illustrative embodiment. The operating environment 100 shown in FIG. 1 includes a server computer 102. The server computer 102 can operate in communication with and/or as part of a communications network (“network”) 104, though this is not necessarily the case.

According to various embodiments, the functionality of the server computer 102 may be provided by one or more server computers, application servers, web servers, desktop computers, other computing systems, and the like. It should be understood that the functionality of the server computer 102 may be provided by a single device, by two or more similar devices, and/or by two or more dissimilar devices. For purposes of describing the concepts and technologies disclosed herein, the server computer 102 is described herein as a server computer. It should be understood that this embodiment is illustrative, and should not be construed as being limiting in any way.

The server computer 102 can execute an operating system (not illustrated in FIG. 1) and one or more application programs such as, for example, a network management service 106. The operating system can include a computer program that can control the operation of the server computer 102. The network management service 106 can include an executable program that can be configured to execute on top of the operating system to provide various functions illustrated and described herein for restoring network configurations using network topology snapshots.

In particular, the network management service 106 can be configured to receive one or more network topology and/or inventory snapshots (“network topology snapshots”) 108 from one or more network monitoring devices or entities (“network monitor”) 110. According to various embodiments of the concepts and technologies disclosed herein, the network topology snapshots 108 can describe, at a particular time, a network configuration associated with the network environment 112 such as a data center, a private network, a public network, and/or other networks and/or networking environments. As used herein, a “network configuration” can be used to refer to, for example, the topology and attributes of one, more than one, and/or all entities associated with the network environment 112; connections between two or more entities of the network environment 112; attributes associated with the one or more entities and/or connections; other aspects of the network environment 112; combinations thereof; or the like.

In some embodiments of the concepts and technologies disclosed herein, the network monitor 110 can generate the network topology snapshots 108 and transmit the network topology snapshots 108 to the server computer 102. In some other embodiments, the network monitor 110 can generate and store the network topology snapshots 108 and the server computer 102 can request and/or otherwise obtain the network topology snapshots 108. Because the network topology snapshots 108 can be obtained by the server computer 102 in additional and/or alternative manners, it should be understood that these examples are illustrative, and therefore should not be construed as being limiting in any way.

According to some embodiments of the concepts and technologies disclosed herein, the network topology snapshots can include data formatted in the JavaScript Object Notation (“JSON”) format. Other data formats are possible and are contemplated such as, for example, data formatted using the Yet Another Markup Language (“YAML”) format; data formatted using the Protocol Buffers (“Protobuf”) format; data formatted in extensible markup language (“XML”); and/or other data formats. In some embodiments, JSON is the preferred format for the network topology snapshots 108, but this is not necessarily the case in all embodiments. As such, it should be understood that these example formats are illustrative, and therefore should not be construed as being limiting in any way.

As mentioned above, the network topology snapshots 108 can describe one or more configurations and/or topologies associated with the network environment 112. As used herein, a “topology” and/or variants thereof can include an inventory associated with the network environment 112, connections between one or more entities included in the network environment 112, attributes associated with the one or more entities and/or connections of the network environment 112, combinations thereof, or the like. Thus, the network topology snapshots 108 can describe the network environment 112 at a particular time including entities operating in and/or with the network environment 112, connections between the entities operating in and/or with the network environment 112, attributes associated with the entities and/or connections, combinations thereof, or the like. Over time, the entities, connections, and/or attributes associated with the network environment 112 can change. According to various embodiments of the concepts and technologies disclosed herein, the network monitor 110 can be configured to detect any change to the entities, connections, and/or attributes, and to generate a network topology snapshot 108 upon the occurrence of any such change.

As such, it can be appreciated that the network topology snapshots 108 can capture changes to the network environment 112, including times at which each change to the network environment 112 occurred. As such, embodiments of the concepts and technologies disclosed herein can use the network topology snapshots 108 to track changes to the network environment 112 and, in some embodiments, times at which these changes were made. Attribute changes can include, for example, ownership associated with an entity (e.g., hardware, software, connections, and/or combinations thereof) in the network environment 112; a location of the entity; an operating state of the entity; a version (e.g., model number, software version, or the like) associated with the entity; one or more other entities with which the entity communicates; sub-entities and/or components of the entity; combinations thereof; or the like. Because other types of entities are contemplated and are possible, it should be understood that these examples are illustrative, and therefore should not be construed as being limiting in any way.

In various embodiments of the concepts and technologies disclosed herein, the server computer 102 can obtain the network topology snapshots 108 and store the network topology snapshots 108 locally and/or remotely. The server computer 102 can be configured to store a network topology snapshot 108 when a network topology snapshot 108 is released by the network monitor 110 (if released by the network monitor 110); when a change is made to the network environment 112; when a network topology snapshot 108 is sent to the server computer 102; and/or at other times. In the illustrated embodiment, the server computer 102 can be configured to store each network topology snapshot 108 that is released by the network monitor 110 and the network monitor 110 can be configured to generate and release a network topology snapshot 108 each time any entity, connection between entities, and/or attribute associated with the entities and/or connections of the network environment 112 is changed. It should be understood that this example is illustrative, and therefore should not be construed as being limiting in any way.

According to various embodiments of the concepts and technologies disclosed herein, the network management service 106 can be configured to obtain and/or store the network topology snapshots 108 and to enable interactions with the network topology snapshots 108 by one or more users or other entities. In the illustrated embodiment, a user or other entity can access the server computer 102, e.g., via a portal, an API, or other functionality (“portal”) 114 using a computing device 116 such as a desktop computer, smartphone, laptop computer, other computing device, or the like. In the illustrated embodiment, the server computer 102 can be configured to expose its functionality to a user or other entity such as the computing device 116 via a web portal or login. It should be understood that this example is illustrative, and therefore should not be construed as being limiting in any way.

The computing device 116 can execute an operating system 118 and one or more application programs 120 such as, for example, a web browser, a standalone application, other application, combinations thereof, or the like. The operating system 118 can include a computer program that can control the operation of the computing device 116 and the application programs 120 can include various executable programs that can be configured to execute on top of the operating system 118 to support interactions between the computing device 116 and the server computer 102. In various embodiments of the concepts and technologies disclosed herein, the application programs 120 can include a web browser for accessing and/or interacting with the server computer 102 via the portal 114. Because the computing device 116 can interact with the server computer 102 in additional and/or alternative manners, it should be understood that this example is illustrative, and therefore should not be construed as being limiting in any way.

In the illustrated embodiment, the server computer 102 can be configured (e.g., via execution of the network management service 106) to generate, and/or to exchange with the computing device 116, session data 122. The session data 122 can also be generated by the computing device 116. Thus, it can be appreciated that the session data 122 can correspond to data exchanged between the server computer 102 and the computing device 116 during a session. It should be understood that this example is illustrative, and therefore should not be construed as being limiting in any way.

The session data 122 can include, for example, data associated with a network management session. According to various embodiments, the session data 122 can include any data exchanged between the computing device 116 and the server computer 102 during the session such as one or more requests, UI data, one or more calculated differences (between network topologies as indicated by the network topology snapshots 108 for example), one or more selections (e.g., selections and/or user input entered via a portal, command prompt, the UI, or the like), other data (e.g., session setup communications, passwords, logins, other data, or the like), combinations thereof, or the like.

The requests can include, for example, a request from the computing device 116 for information relating to topologies of the network environment 112, service calls or the like for invoking the network management service 106, a request to calculate differences between two or more network topology snapshots 108, and/or other requests. In some embodiments, the requests can be sent to the server computer 102 by the computing device 116 via one or more network connections such as via the network 104 and/or the network environment 112. In some other embodiments, the requests can be “sent” to the server computer 102 via the portal 114 or other functionality, for example via a web page or the like, which can be provided to the computing device 116 via the session data 122 in some embodiments. Because the requests can be received by the server computer 102 in additional and/or alternative manners, it should be understood that these examples are illustrative, and therefore should not be construed as being limiting in any way.

The UI data can include, for example, display data that, when executed by the application programs 120, can cause the computing device 116 to present a web page, application, or other display via which a user or other entity can view and/or interact with network configurations and/or topologies associated with the network environment 112, differences between two or more network configurations and/or topologies associated with the network environment 112, and/or attributes associated with the configurations and/or topologies associated with the network environment 112.

The calculated differences can include one or more differences between two network configurations and/or topologies. Thus, the differences can indicate one or more attributes, entities, and/or connections of the network environment 112 that have changed over some time (e.g., between times associated with a first network topology snapshot 108 and a second network topology snapshot 108). In some embodiments, as noted above, the network topology snapshots 108 can correspond to JSON files and the differences can be calculated by comparing the network topology snapshots 108. For example, one contemplated embodiment of the concepts and technologies disclosed herein can calculate the differences by executing the following code or other code that may be similar to the following request:

```
}
{
  ″operations : [
        {
            ″action″:″put″,
            ″body″: {
                  ″fqdn″:″pserver-key-fqdn″,
                  ″hostname :″pserver-1-key″
        },
            ″uri″: ″/cloud-infrastructure/pserver/pserver /
            pserver-1-key″
        },
        {
            ″action″ :″patch″,
            ″body″ : {
                  ″fqdn″:″patched-fqdn″
            },
            ″uri″ :″/cloud-infrastructure/pservers/pstrver/
            pserver-1-key″
        },
        {
            ″action″ :″put″,
            ″body″ : {
                  ″fqdn″ :″pserver-key-fqdn″,
                  ″hostname″ :″pserver-2-key″
        },
            ″uri″ :″/cloud-infrastructure/pservers/pserver/
            pserver-2-key″
        }
  ]
}
```

In the above example bulk single-transaction API request and response sample payloads, node creates (e.g., put action lines) and updates (e.g., patch action lines) are shown. It should be understood that the concepts and technologies disclosed herein also support delete actions that can show node removal. In response to the above request, the following response can be generated, in the example embodiment:

```
{
  ″operation-responses : [
        {
        ″action″:″put″,
        ″response-body″: null,
        ″response-status-code″ : 201,
        ″uri″:″/cloud-infrastructure/pservers/pserver/
        pserver-1-key″
        },
        {
        ″action″:″patch″,
        ″response-body″: null,
        ″response-status-code″ : 200,
        ″uri″:″/cloud-infrastructure/pservers/pserver/
        pserver-1-key″
        }
        {
        ″action″:″put″,
        ″response-body″: null,
        ″response-status-code″ : 201,
        ″uri″:″/cloud-infrastructure/pservers/pserver/
        pserver-2-key″
        }
  ]
}
```

In another embodiment, a request that includes delete lines can include the following example request:

```
{
  ″operations″: [
        {
            ″action″: ″put″,
            ″body″: {
                  ″fqdn″: ″pserver-key fqdn″,
                  ″hostname ″: ″pserver-key″
        },
            ″uri″: /cloud-infrastructure/pservers/
            oserver /pserver-key″
        },
        {
            “action”:”put”,
            ″body ″: {
                  ″city″:″city″,
                  ″country″:″NONE″,
                  ″data-center-code″ : ″code″,
                  ″identity-url″:″N/A″,
                  ″physical-location-id″:″complex-key″,
                  ″physical-location-type : ″type″
                  ″postal-code″:″12345″,
                  ″region″:″Earth″,
                  ″state″: ″state″,
                  ″street1″:″street″
        },
        “uri″: “/cloud-infrastructure/complexes/
        complex/complex-key″
        },
        {
            ″action″ : ″put″,
            ″body″ : {
                  ″related link″: ″/aai/v13/cloud-
                  infrastructure/pservers/pserver/pserver-key″,
                  ″related-to″:″pserver″
        },
            ″uri″:″/cloud-infrastructure/complexes/complex/
            complex-key/relationship-list/relationship″
        },
        {
        ″action′′′:′′′delete″,
        ″body″: { },
        ″uri″: ″/network /generic-vnfs/generic-vnf/gvnf-key?
        resource-version=0″
        }
  ]
}
```

And a response to the above request can include the following response:

```
{
  ″operation-responses : [
        {
        ″action″:″put″,
        ″response-body″: null,
        ″response-status-code″ : 201,
        ″uri″:″/cloud-infrastructure/pservers/pserver/pserver-key″
        },
        {
        ″action″:″put″,
        ″response-body″: null,
        ″response-status-code″ : 201,
        ″uri″:″/cloud-infrastructure/complexes/complex/complex-key″
        },
        {
        ″action″:″put″,
        ″response-body″: null,
        ″response-status-code″ : 200,
        ″uri″:″/cloud-infrastructure/complexes/complex/complex-key/relationship-
        list/relationship″
        },
        {
        ″action″:″delete″,
        ″response-body″: null,
        ″response-status-code″ : 204,
        ″uri″:″/network/generic-virtual network functions/generic-virtual network
        function/gvnf-key?resource-version=0″
        }
  ]
}
```

Because differences between two or more configurations and/or topologies associated with the network environment 112 can be determined in additional and/or alternative manners, it should be understood that this example is illustrative, and therefore should not be construed as being limiting in any way.

The selections can include, for example, one or more instances of user input and/or selections. For example, the selections can correspond to interactions the user has with one or more UIs to indicate, for example, one or more entities, connections, and/or attributes to restore for a network configuration and/or topology. In some embodiments, the selections can include Boolean indicators. For example, each attribute that can be restored can have an associated check box or other selector for a user or other entity to indicate if the associated attribute is to be rolled back, reverted, and/or restored. Thus, the selections can correspond to the selection or deselection of the associated check boxes or the like. Because the selections of the user or other entity can be indicated in additional and/or alternative manners, it should be understood that these examples are illustrative, and therefore should not be construed as being limiting in any way.

The other data can include, for example, session setup data, passwords, IDs, location information, user information, organization information, encrypted information, encryption/decryption key information, other information, combinations thereof, or the like. Thus, it should be understood that the other data can include almost any information that may be used in accordance with the various embodiments of the concepts and technologies disclosed herein.

Via the exchange of session data 122 between the computing device 116 and the server computer 102, one or more network topology snapshots 108 can be viewed and two or more network topology snapshots 108 can be compared to one another; the network environment 112 can be restored to include aspects of one or more previous network topologies associated with the network environment 112; and/or other operations can be performed with respect to topologies of the network environment 112. If a selection (of the session data 122) indicates that a configuration (e.g., a topology and/or aspects of a topology) of the network environment 112 is or are to be restored, the network management service 106 can be configured to perform one or more operations for implementing the requested restoration.

In particular, the network management service 106 can be configured to analyze the one or more selections to detect one or more aspects of the topology of the network environment 112 that are to be restored and to generate one or more instances of executable code (“commands”) 124 that, when executed by an entity associated with the network environment 112 such as an orchestration service 126, will cause the orchestration service 126 to restore the configuration of the network environment 112 as requested. In various embodiments of the concepts and technologies disclosed herein, the selections can indicate that attributes associated with one or more entities are to be restored.

In various embodiments of the concepts and technologies disclosed herein, a user is not required to restore a configuration of the network environment 112 in whole (e.g., to restore all entities and connections associated with a particular network topology snapshot 108 to their state at a time associated with the network topology snapshot 108). Rather, embodiments of the concepts and technologies disclosed herein enable a user or other entity to specify one, more than one, or all entities and/or connections associated with a particular network topology snapshot 108 that are to be restored to a previous state. Thus, the concepts and technologies disclosed herein can restore attributes, entities, connections, and/or other aspects of a network configuration without restoring all attributes, entities, connections, and/or other aspects of the network configuration. It should be understood that this example is illustrative, and therefore should not be construed as being limiting in any way.

The server computer 102 can generate the commands 124 and transmit the commands 124 directed to the orchestration service 126 and/or one or more other entities. The orchestration service 126 or other entity can alter one or more entities, connections, and/or attributes associated with the network environment 112 to restore the network environment 112 as indicated in the session data 122. Thus, a user or other entity can interact with the server computer 102 to compare present and previous network configurations, to identify differences therebetween, and/or to selectively revert one or more aspects of the network configurations to a previous state in some embodiments. It should be understood that this example is illustrative, and therefore should not be construed as being limiting in any way.

In practice, a network environment 112 can be monitored by one or more network monitoring devices such as the network monitor 110. The network monitor 110 can capture one or more network topology snapshots 108 that define and/or describe a topology and/or configuration associated with the network environment 112 at a particular time. According to various embodiments of the concepts and technologies disclosed herein, the network monitor 110 can be configured to capture the network topology snapshots 108 each time a configuration and/or topology associated with the network environment 112 is changed, thereby capturing entities included in the topology of the network environment 112; one or more connections between the entities; one or more attributes associated with the entities and/or connections; other attributes; combinations thereof; or the like. The network monitor 110 can release the network topology snapshots 108 to the server computer 102 and/or make the network topology snapshots 108 available to one or more requestors such as, for example, the server computer 102.

The server computer 102 can store copies of the network topology snapshots 108 and/or access and/or use the network topology snapshots 108 to provide functionality as illustrated and described herein for restoring network configurations using the network topology snapshots 108. According to various embodiments of the concepts and technologies disclosed herein, the server computer 102 can host and/or execute a network management service 106 that can be accessed via a portal, API, or other functionality by a device such as, for example, the computing device 116. It should be understood that this example is illustrative, and therefore should not be construed as being limiting in any way.

Via exchanges of session data 122 between the computing device 116 and the server computer 102, the user and/or other entity associated with the computing device 116 can submit requests to the server computer 102; the server computer 102 can receive the requests from the computing device 116; the server computer 102 can send UI data to the computing device 116; the computing device 116 can receive the UI data from the server computer 102; the server computer 102 can send calculated differences to the computing device 116; the computing device 116 can receive the calculated differences from the server computer 102; the computing device 116 can submit one or more selections (or data that describe the selections) to the server computer 102; the server computer 102 can receive the selections from the computing device 116; and the devices can exchange other data. By way of the session data 122, the computing device 116 can indicate one or more configurations to restore at the network environment 112.

The server computer 102 (e.g., via execution of the network management service 106) can identify the attributes, entities, and/or connections (configurations) associated with the network environment 112 that are to be restored and generate one or more commands 124 for implementing the restoration of those attributes, entities, and/or connections. The server computer 102 (e.g., via execution of the network management service 106) can send the commands 124 to an orchestration service 126 or other entity that can implement the configuration restoration at the network environment 112. As such, a user or other entity can selectively restore network configurations using network topology snapshots 108.

FIG. 1 illustrates one server computer 102, one network 104, one network environment 112, one network monitor 110, one computing device 116, and one orchestration service 126. It should be understood, however, that various implementations of the operating environment 100 can include zero, one, or more than one server computer 102; zero, one, or more than one network 104; one or more than one network environment 112; zero, one, or more than one network monitor 110; zero, one, or more than one computing device 116; and/or zero, one, or more than one orchestration service 126. As such, the illustrated embodiment should be understood as being illustrative, and should not be construed as being limiting in any way.

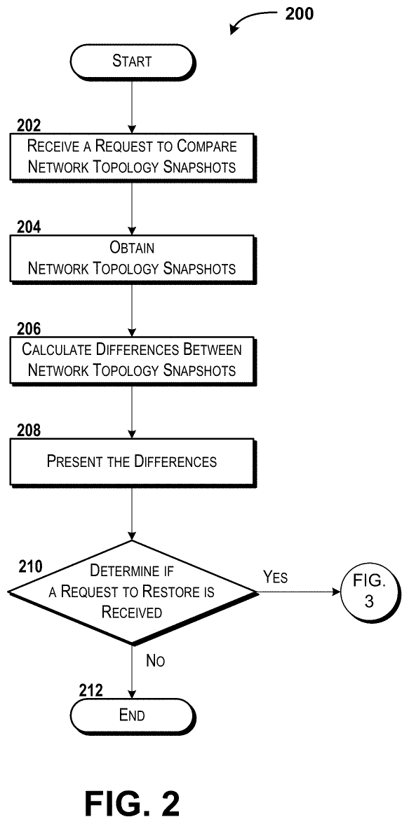

Turning now to FIG. 2, aspects of a method 200 for restoring a network configuration using network topology snapshots will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the computing device 116 or the server computer 102, to perform one or more operations and/or causing the processor to direct other components of the computing system or device to perform one or more of the operations.

For purposes of illustrating and describing the concepts of the present disclosure, the method 200 is described herein as being performed by the server computer 102 via execution of one or more software modules such as, for example, the network management service 106. It should be understood that additional and/or alternative devices and/or network nodes can provide the functionality described herein via execution of one or more modules, applications, and/or other software including, but not limited to, the network management service 106. Thus, the illustrated embodiments are illustrative, and should not be viewed as being limiting in any way.

The method 200 begins at operation 202. At operation 202, the server computer 102 can receive a request to compare network topology snapshots such as the network topology snapshots 108. In some embodiments, the request received in operation 202 can correspond to a command, a service call, or an explicit request, any and/or all of which may be created by the computing device 116 via interactions with the server computer 102 via the portal 114 and/or other interfaces. In some embodiments, the computing device 116 may connect to the server computer 102 (e.g., via accessing the portal 114 using a web browser, application, or other functionality such as the application programs 120) and that connection may be understood by the server computer 102 as corresponding to a request to compare network topology snapshots 108. Because the request received (or detected) in operation 202 can be received in additional and/or alternative manners, it should be understood that these examples are illustrative, and therefore should not be construed as being limiting in any way.

From operation 202, the method 200 can proceed to operation 204. At operation 204, the server computer 102 can obtain two or more network topology snapshots 108. In some embodiments, the server computer 102 can store the network topology snapshots 108 and can retrieve two or more network topology snapshots 108 from a local storage device. In some other embodiments, the network topology snapshots 108 may be stored at a remote data storage device or entity, and operation 204 therefore can correspond to the server computer 102 obtaining the network topology snapshots 108 from another device. Because the network topology snapshots 108 can be obtained or retrieved in various matters, it should be understood that these examples are illustrative, and therefore should not be construed as being limiting in any way.

In some embodiments, the server computer 102 can obtain two or more network topology snapshots 108 for operation 204, with the server computer 102 obtaining the most current network topology snapshot 108 and a previous network topology snapshot 108 (the version before a change or changes that resulted in a most current network topology snapshot 108). In some other embodiments, the server computer 102 can be configured to access all network topology snapshots for a network environment 112 and/or portion thereof (e.g., a subnet). As such, it should be understood that operation 204 can correspond to the server computer 102 obtaining two or more network topology snapshots 108. It should be understood that this example is illustrative, and therefore should not be construed as being limiting in any way.

From operation 204, the method 200 can proceed to operation 206. At operation 206, the server computer 102 can calculate differences between the two or more network topology snapshots 108 obtained in operation 204. In some example embodiments, the network topology snapshots 108 can include JSON files (as explained above with reference to FIG. 1) and/or files in other formats. Thus, operation 206 can include calculating differences between the JSON files. Regardless of the format of the network topology snapshots 108, operation 206 can correspond to determining all differences in the network environment 112 as captured in the most current network topology snapshot 108 and one or more network topology snapshots 108 captured at previous times.

In some embodiments, the server computer 102 can determine each entity added to the network environment 112 over time (e.g., from one or more network topology snapshots 108 and the most current network topology snapshot 108); each entity removed from the network environment 112 over time (e.g., from one or more network topology snapshots 108 and the most current network topology snapshot 108); each connection added, modified, and/or deleted between two or more entities in the network environment 112 over time (e.g., from one or more network topology snapshots 108 and the most current network topology snapshot 108); each entity attribute and/or connection attribute added, changed, and/or deleted with respect to entities and/or connections in the network environment 112 over time (e.g., from one or more network topology snapshots 108 and the most current network topology snapshot 108); other changes; combinations thereof; or the like. Thus, operation 206 can include the comparison of the two or more network topology snapshots 108 and storing or caching those differences for presentation to a user or other entity.

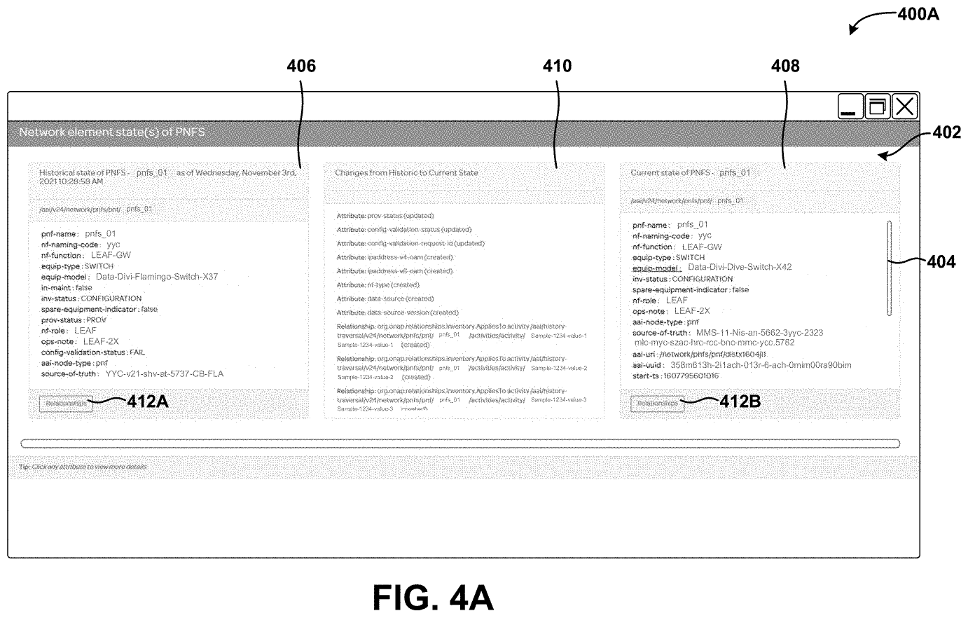

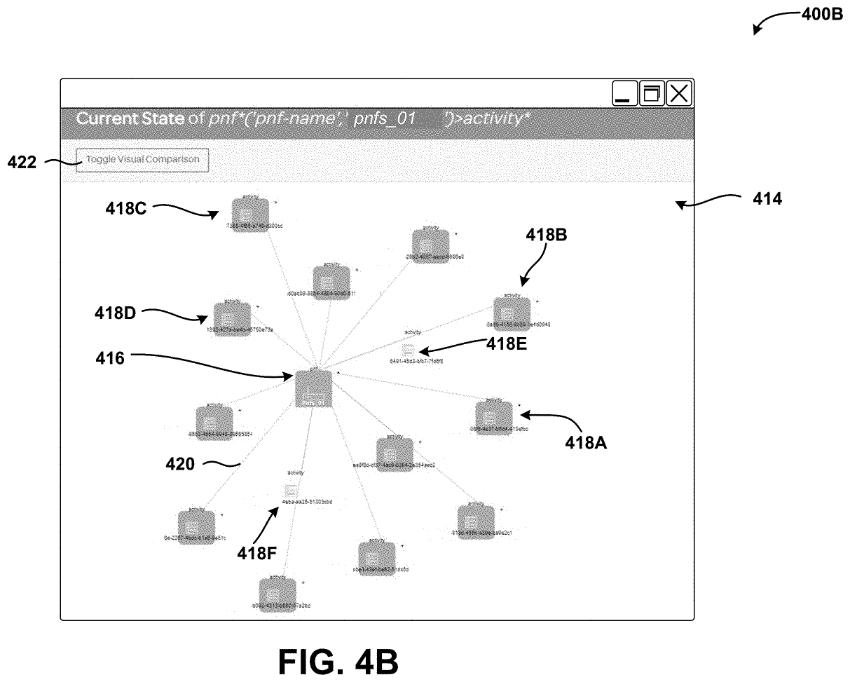

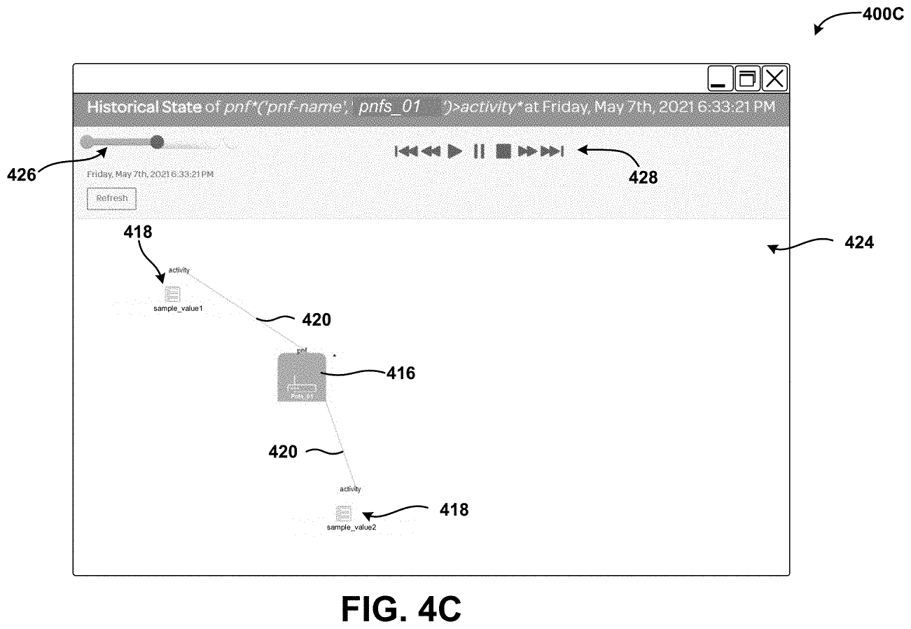

From operation 206, the method 200 can proceed to operation 208. At operation 208, the server computer 102 can present or provide the differences between the network topology snapshots 108. In some embodiments, the differences can be presented in one or more UIs (e.g., the UIs illustrated and described below with reference to FIGS. 4A-4C) and/or in other ways. In one contemplated embodiment, a representation (e.g., a graph, a list, or the like) of a current topology of the network environment 112 (or portion of the network environment 112) can be presented along with another representation (e.g., a graph, a list, or the like) of a previous topology of the network environment 112 (or portion of the network environment 112). It should be understood that this example is illustrative, and therefore should not be construed as being limiting in any way.

In some embodiments, the presentation and/or providing of the differences in operation 208 includes presenting a representation (e.g., a graph, a list, or the like) of a current topology of the network environment 112 (or portion of the network environment 112) and showing all changes to the network environment 112 or portion thereof over time as captured by all of the available network topology snapshots 108 associated with the network environment 112 and/or portion thereof. In any event, the presentation of the differences can include presenting options for a user or other entity to select one or more entity, connection, and/or attribute that is to be changed to a previous operating state. Example UIs for enabling these and/or other features as illustrated and described herein will be illustrated and described below with reference to FIGS. 4A-4C. It should be understood that this example is illustrative, and therefore should not be construed as being limiting in any way.

From operation 208, the method 200 can proceed to operation 210. At operation 210, the server computer 102 can determine if a request to restore is received. In the context of operation 210, the request to restore can include a request to restore a previous configuration and/or operating state associated with one or more entities and/or connections of the network environment 112. A user or other entity can select any number of entities, connections, and/or attributes that are to be restored from one or more previous times and is not required in embodiments of the concepts and technologies disclosed herein to restore operating state and/or configuration of all entities, connections, and/or attributes of the network environment 112.

For example, a network environment 112 or portion thereof may have two entities and one connection therebetween at a first time. These entities and connections can be represented by a first network topology snapshot 108. The network environment 112 or portion thereof can have four entities and six connections between these entities at a second time. These entities and connections can be represented by a second network topology snapshot 108. The network environment 112 or portion thereof can have three entities and three connections between these entities at a third time. These entities and connections can be represented by a third network topology snapshot 108.

A user or other entity may be enabled to selectively restore a connection and/or entity that has been removed between two or more times (e.g., restore an entity removed and/or remove a connection added, etc.). Any change to any entity, connection, or attribute can be selectively (and independently) reverted to any time according to various embodiments of the concepts and technologies disclosed herein without restoring other operating states, configurations, and/or attributes associated with entities and/or connections at that time. Thus, embodiments of the concepts and technologies disclosed herein can provide very specific restoration that can be limited in scope by users and/or other entities, and operation 210 can correspond to determining if a user or other entity has indicated that one or more configuration changes are to be reverted, in some embodiments. It should be understood that this example is illustrative, and therefore should not be construed as being limiting in any way.

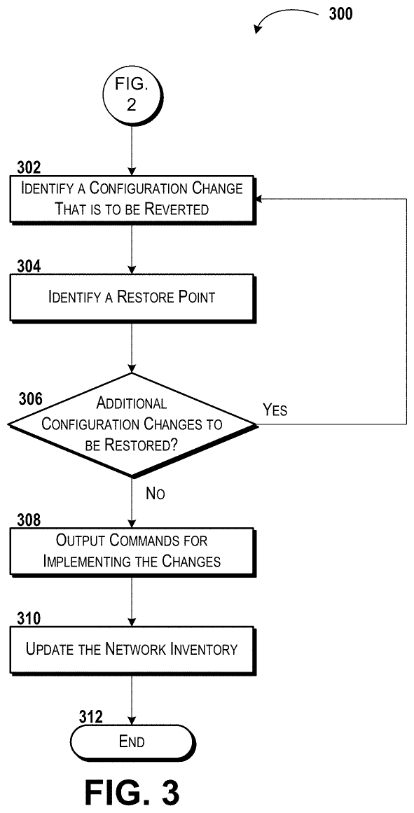

If the server computer 102 determines, in operation 210, that a request to restore has not been received, the method 200 can proceed to operation 212. The method 200 can end at operation 212. If the server computer 102 determines, in operation 210, that a request to restore has been received, flow can proceed with the operations of the method 300 shown in FIG. 3.

Turning now to FIG. 3, aspects of a method 300 for restoring a network configuration using network topology snapshots will be described in detail, according to an illustrative embodiment. For purposes of illustrating and describing the concepts of the present disclosure, the method 300 is described herein as being performed by the server computer 102 via execution of one or more software modules such as, for example, the network management service 106. It should be understood that additional and/or alternative devices and/or network nodes can provide the functionality described herein via execution of one or more modules, applications, and/or other software including, but not limited to, the network management service 106. Thus, the illustrated embodiments are illustrative, and should not be viewed as being limiting in any way.

The method 300 begins at operation 302. At operation 302, the server computer 102 can identify or determine a configuration change that is to be reverted. As explained herein, a user or other entity may be presented with one or more UIs for identifying one or more configuration changes that are to be reverted, so operation 302 can correspond to the server computer 102 determining if one or more selections received from the computing device 116 (e.g., as the selections included in the session data 122) have been received. Although in some embodiments all configuration changes that are to be reverted can be identified at a single time and/or a single iteration of the session data 122 or other data, the method 300 is illustrated and described with reference to an embodiment in which a single configuration change reversion/restoration is determined to have been requested in operation 302. It should be understood that this example is illustrative, and therefore should not be construed as being limiting in any way.

From operation 302, the method 300 can proceed to operation 304. At operation 304, the server computer 102 can identify a restore point (e.g., a point in time, a number of iterations to be reverted, etc.) for the configuration change that is to be reverted as identified in operation 302. It can be appreciated that the user or other entity can provide input and/or selections that can identify one or more changes to configurations, as explained in detail herein. Thus, operation 304 can include the server computer 102 determining that a user or other entity has selected or provided input for designating a restore point associated with the state to which the configuration change is to be reverted. Thus, operation 304 can correspond to the server computer 102 determining, for the one or more configuration reversions to be implemented, a restore point associated with that reversion (e.g., the configuration may have changed three or more times, in which case the server computer 102 can determine which of the two or more previous configurations is to be reapplied and/or reverted to by way of the requested reversion). It should be understood that this example is illustrative, and therefore should not be construed as being limiting in any way.

From operation 304, the method 300 can proceed to operation 306. At operation 306, the server computer 102 can determine if additional configuration changes are to be reverted and/or restored. As noted above, some embodiments of the concepts and technologies disclosed herein can include identifying all configuration changes that are to be reverted at a single time and/or in a single iteration of the session data 122 or other data, in which case operation 306 may include identifying all configuration changes that are to be made. In the illustrated embodiment, in which a single configuration change reversion/restoration is determined to have been requested in operation 302, operation 306 can correspond to determining if any other configuration changes have been requested for reverting. It should be understood that this example is illustrative, and therefore should not be construed as being limiting in any way.

If the server computer 102 determines, in operation 306, that additional configuration changes are to be reverted, the method 300 can return to operation 302, and an additional configuration change that is to be reverted can be identified. Operations 302 through 306 can be iterated until the server computer 102 determines, in any iteration of operation 306, that there are no additional configuration changes that are to be reverted.

If the server computer 102 determines, in any iteration of operation 306, that there are no additional configuration changes that are to be reverted, the method 300 can proceed to operation 308. At operation 308, the server computer 102 can output commands 124 for implementing the one or more configuration changes identified over one or more iterations of operations 302-306. Thus, operation 308 can include the server computer 102 generating the commands 124 for implementing the one or more configuration changes, though this is not separately illustrated in FIG. 3. As noted above, the commands 124 can include executable code and/or identifiers that can be implemented and/or used by the orchestration service 126 and/or other entities to make changes to the network environment 112 to revert the configurations of the network environment 112 and/or portions thereof as illustrated and described herein.

In some embodiments of the concepts and technologies disclosed herein, the generating and/or outputting of the commands 124 can be performed for each configuration change identified (e.g., before the functionality of operation 306), while in some other embodiments such as the example embodiment shown in FIG. 3, the generating and/or outputting of the commands 124 can be performed in bulk for two or more, or even all, configuration changes identified through one or more iterations of operations 302-306. It should be understood that these examples are illustrative, and therefore should not be construed as being limiting in any way.

From operation 308, the method 300 can proceed to operation 310. At operation 310, the server computer 102 can update the network inventory and/or obtain an updated network topology snapshot 108 that reflects the changes implemented by way of the methods 200, 300. In some embodiments, the network monitor 110 may issue an updated network topology snapshot 108 when any change to the network environment 112 (and/or portion thereof) is detected, as noted above, so operation 310 can correspond to the server computer 102 receiving an updated network topology snapshot 108. In some other embodiments, the server computer 102 can trigger changes to the network topology snapshot 108 and/or trigger delivery of an updated network topology snapshot 108. Because the inventory, topology, and/or configurations associated with the network environment 112 can be updated and/or reflected in additional and/or alternative manners, it should be understood that these examples are illustrative, and therefore should not be construed as being limiting in any way.

From operation 310, the method 300 can proceed to operation 312. The method 300 can end at operation 312.

FIGS. 4A-4C are user interface (“UI”) diagrams showing aspects of UIs for using, interacting with, and/or controlling aspects of the network management service 106, according to some illustrative embodiments of the concepts and technologies disclosed herein. FIG. 4A shows an illustrative screen display 400A. According to some embodiments of the concepts and technologies described herein, the screen display 400A can be generated by the computing device 116 via interactions with the network management service 106 (e.g., by accessing the server computer 102 via the portal 114 and rendering display data provided to the computing device 116 via the portal 114, for example).

In particular, according to various embodiments, the computing device 116 can generate the screen display 400A and/or other screen displays in conjunction with and/or based upon interactions with the network management service 106 described herein, which can be configured to render the screen display 400A using data generated at the computing device 116 and/or using data provided by the server computer 102 (e.g., the network management service 106), for example, the session data 122 illustrated and described herein. It should be appreciated that the UI diagram illustrated in FIG. 4A is illustrative of one contemplated example of the UIs that can be generated and/or displayed in accordance with the concepts and technologies disclosed herein, and therefore should not be construed as being limited in any way.

According to various embodiments, the screen display 400A can be presented, for example, when a computing device 116 receives data detailing a comparison of network topology snapshots 108. For example, the screen display 400A can be presented in response to the computing device 116 receiving data from the server computer 102 (e.g., the session data 122) in response to the server computer 102 performing operation 208 of the method 200. Of course, the computing device 116 may present the calculated differences between two or more network topology snapshots 108 at additional and/or alternative times, so it should be understood that the above example is illustrative and therefore should not be construed as being limiting in any way.

The screen display 400A can include various menus and/or menu options (not shown in FIG. 4A). The screen display 400A also can include a configuration comparison window 402. The configuration comparison window 402 can be configured to present configuration and/or state changes in the network environment 112 (or a portion thereof) between two or more points in time such as, for example, a current configuration and a previous configuration. The configuration comparison window 402 can include a list of one or more entities and/or connections and their associated attributes for the network environment 112 at two or more points in time. Thus, the configuration comparison window 402 can include a scroll bar 404 or other UI functionality for scrolling through the lists or other depictions of the entities and/or connections and their associated attributes for the network environment 112 at two or more points in time. It should be understood that this example is illustrative, and therefore should not be construed as being limiting in any way.

As shown in FIG. 4A, the configuration comparison window 402 can include a historical state section 406, a current state section 408, and a changes section 410. The historical state section 406 can show a list of entities, connections, and their associated attributes at a particular point in time. The current state section 408 can show a list of entities, connections, and their associated attributes at a current point in time. The changes section 410 can show a list of entities, connections, and/or their associated attributes that have changed between the point in time associated with the historical state section 406 and the current time. As such, it can be appreciated that the configuration comparison window 402 can show two configurations associated with the network environment 112 or a portion thereof (e.g., a current configuration and a previous configuration) and differences between these two configurations (e.g., changes that were made to entities, connections, and/or attributes). It should be understood that this example is illustrative, and therefore should not be construed as being limiting in any way.

The configuration comparison window 402 also can include one or more display relationships selectors 412A-B (hereinafter collectively and/or generically referred to as display relationships selectors 412). Selection of one of the display relationships selector 412 can cause the computing device 116 to present a graph and/or other visual representation of the configuration depicted in the associated section (e.g., the display relationships selector 412A can be associated with the historical state section 406 and the display relationships selector 412B can be associated with the current state section 408). Thus, selection of the display relationships selector 412A can cause the computing device 116 to present a graphical representation of the historical state (e.g., previous configuration) associated with the network environment 112 and/or a portion thereof and selection of the display relationships selector 412B can cause the computing device 116 to present a graphical representation of the current state (e.g., current configuration) associated with the network environment 112 and/or a portion thereof. It should be understood that this example is illustrative, and therefore should not be construed as being limiting in any way.

As can be seen in the changes section 410, attributes that have been changed between the two or more configurations depicted in the configuration comparison window 402 can include additional information such as, for example, if the entity, connection, and/or attribute has been created, deleted, and/or modified; an entity that made the change; and/or additional and/or alternative information. In some embodiments of the concepts and technologies disclosed herein, each attribute that has been changed can be accompanied, for example, by a checkbox and/or other functionality for selecting or deselecting that entity, connection, and/or attribute (e.g., for selectively indicating which, if any, entities, connections, and/or attributes are to be reverted). It should be understood that this example is illustrative, and therefore should not be construed as being limiting in any way. Because additional or alternative controls (e.g., a “revert configuration option”) can be included in the configuration comparison window 402, it should be understood that the example embodiment shown in FIG. 4A is illustrative and therefore should not be construed as being limiting in any way.

FIG. 4B shows another illustrative screen display 400B that can be generated by the computing device 116 via interactions with the network management service 106. In particular, according to various embodiments, the computing device 116 can generate the screen display 400B and/or other screen displays in conjunction with, based on, and/or in response to detecting selection of the display relationships selector 412B illustrated and described above with reference to FIG. 4A. Because the screen display 400B can be displayed at additional and/or alternative times, it should be understood that this example is illustrative, and therefore should not be construed as being limiting in any way. Furthermore, it should be appreciated that the UI diagram illustrated in FIG. 4B is illustrative of one contemplated example of the UIs that can be generated and/or displayed in accordance with the concepts and technologies disclosed herein, and therefore should not be construed as being limited in any way.

The screen display 400B can include various menus and/or menu options (not shown in FIG. 4B). The screen display 400B also can include a display current configuration window 414. The display current configuration window 414 can be configured to present a visual representation of the configuration and/or state of the network environment 112 (or a portion thereof). In the illustrated embodiment, the display current configuration window 414 is illustrated as displaying a configuration for a single entity, in this case a particular physical network function (“PNF”). It should be understood that this example is illustrative, and therefore should not be construed as being limiting in any way.

The display current configuration window 414 can include a graph or diagram of the current state and/or configuration of the network environment 112 or a portion thereof including one or more entity representations 416 (FIG. 4B shows only one); one or more activity representations 418A-D (hereinafter collectively and/or generically referred to as activity representations 418)(only six are labeled in FIG. 4B but fifteen are shown), and one or more inheritance lines 420 (only one is labeled in FIG. 4B, but fifteen are shown). Because other representations can be shown (e.g., connections, etc.), it should be understood that this example is illustrative, and therefore should not be construed as being limiting in any way.

The entity representation 416 can identify a particular entity such as a virtual network function, a physical network function, a connection, a piece of hardware, or other asset associated with the network environment 112 and/or a portion thereof. The entity representation 416 can correspond to a UI control that, when selected, can cause the computing device 116 or other device displaying the screen display 400B to generate a flyout or other window for presenting information associated with the entity that corresponds to the entity representation 416 (e.g., name, type of entity, installation date, operating state, attributes, etc.). It should be understood that this example is illustrative, and therefore should not be construed as being limiting in any way.

The activity representations 418 can represent activities that have occurred in association with the entity represented by the entity representation 416. The activity representations 418 can employ color coding in some embodiments, though other indicators (e.g., text indicators, icon changes, etc.) are contemplated. The color coding in the example embodiment shown in FIG. 4B using a green highlight option to highlight activities that have occurred since a previous point in time (e.g., the previous point in time associated with the historical state section 406 shown in FIG. 4A). The two activity representations 418E-F that are not highlighted have not been changed in this example embodiment since the previous point in time associated with the historical state section 406 shown in FIG. 4A. It should be understood that this example is illustrative, and therefore should not be construed as being limiting in any way.

The activities can include attribute changes, entity moves, name changes, ownership changes, and/or other changes, additions, and/or deletions. Thus, it can be appreciated that at least thirteen actions have occurred with respect to the entity represented by the entity representation 416 between some previous time and the current time. It should be understood that this example is illustrative, and therefore should not be construed as being limiting in any way.

The inheritance lines 420 can indicate which entity the action representations are associated. In some instances, multiple entities can be represented by the display current configuration window 414, so the activity representations 418 displayed may be associated with multiple entities. Thus, the inheritance lines 420 can indicate which entity the actions are associated with. It should be understood that this example is illustrative, and therefore should not be construed as being limiting in any way.

As shown in FIG. 4B, the display current configuration window 414 also can include a toggle visual comparison option 422. Selection of the toggle visual comparison option 422 can cause the computing device 116 to show a historical state of the entity (and/or multiple entities and/or connections associated with the network environment 112 and/or a portion thereof). It should be understood that this example is illustrative, and therefore should not be construed as being limiting in any way. Because additional or alternative controls can be included in the display current configuration window 414, it should be understood that the example embodiment shown in FIG. 4B is illustrative and therefore should not be construed as being limiting in any way.

FIG. 4C shows another illustrative screen display 400C that can be generated by the computing device 116 via interactions with the network management service 106. In particular, according to various embodiments, the computing device 116 can generate the screen display 400C and/or other screen displays in conjunction with, based on, and/or in response to detecting selection of the display relationships selector 412A illustrated and described above with reference to FIG. 4A and/or in response to other actions. Because the screen display 400C can be displayed at additional and/or alternative times, it should be understood that this example is illustrative, and therefore should not be construed as being limiting in any way. Furthermore, it should be appreciated that the UI diagram illustrated in FIG. 4C is illustrative of one contemplated example of the UIs that can be generated and/or displayed in accordance with the concepts and technologies disclosed herein, and therefore should not be construed as being limiting in any way.

The screen display 400C can include various menus and/or menu options (not shown in FIG. 4C). The screen display 400C also can include a display historical configuration window 424. The display historical configuration window 424 can be configured to present a visual representation of the configuration and/or state of the network environment 112 (or a portion thereof) at some previous time, e.g., the time associated with the historical state section 406 of the screen display 400A shown in FIG. 4A. It should be understood that this example is illustrative, and therefore should not be construed as being limiting in any way. In the illustrated embodiment, the display historical configuration window 424 is illustrated as displaying a configuration for a single entity, in this case a particular physical network function (“PNF”). Because more than one entity can be shown in the display historical configuration window 424, it should be understood that this example is illustrative, and therefore should not be construed as being limiting in any way.

The display historical configuration window 424 can include a graph or diagram of the past state and/or configuration of the network environment 112 or a portion thereof including one or more entity representations 416 (FIG. 4C shows one); one or more activity representations 418 (two are shown in FIG. 4C), and one or more inheritance lines 420 (two are shown). Because other representations can be shown (e.g., connections, etc.), it should be understood that this example is illustrative, and therefore should not be construed as being limiting in any way.

As can be appreciated with collective reference to FIGS. 4B-4C, about thirteen actions have occurred with respect to the entity represented by the entity representation 416 in FIG. 4C since some previous time, e.g., a point in time associated with the historical state section 406 of the screen display 400A shown in FIG. 4A. It should be understood that this example is illustrative, and therefore should not be construed as being limiting in any way.

As shown in FIG. 4C, the display historical configuration window 424 also can include a time selector and indicator 426, which can illustrate a time represented by the representations shown in the display historical configuration window 424. The time selector and indicator 426 can correspond to a selectable UI control in some embodiments, by which a user or other entity can navigate through two or more configuration changes. It should be understood that this example is illustrative, and therefore should not be construed as being limiting in any way.

The display historical configuration window 424 also can include animation controls 428, which can be used to animate the changes to the configurations illustrated by the display historical configuration window 424. Thus, for example, selection of a “play” button can cause the computing device 116 to animate changes to the configuration of the network environment 112 (or a portion thereof) over time. Other controls can include controls for advancing through network topology snapshots 108, stop controls, fast forward controls, reverse controls, and other controls as generally is understood. Because other controls can be displayed, it should be understood that these examples are illustrative, and therefore should not be construed as being limiting in any way. Also, it should be understood that the example embodiment shown in FIG. 4C is illustrative and therefore should not be construed as being limiting in any way.

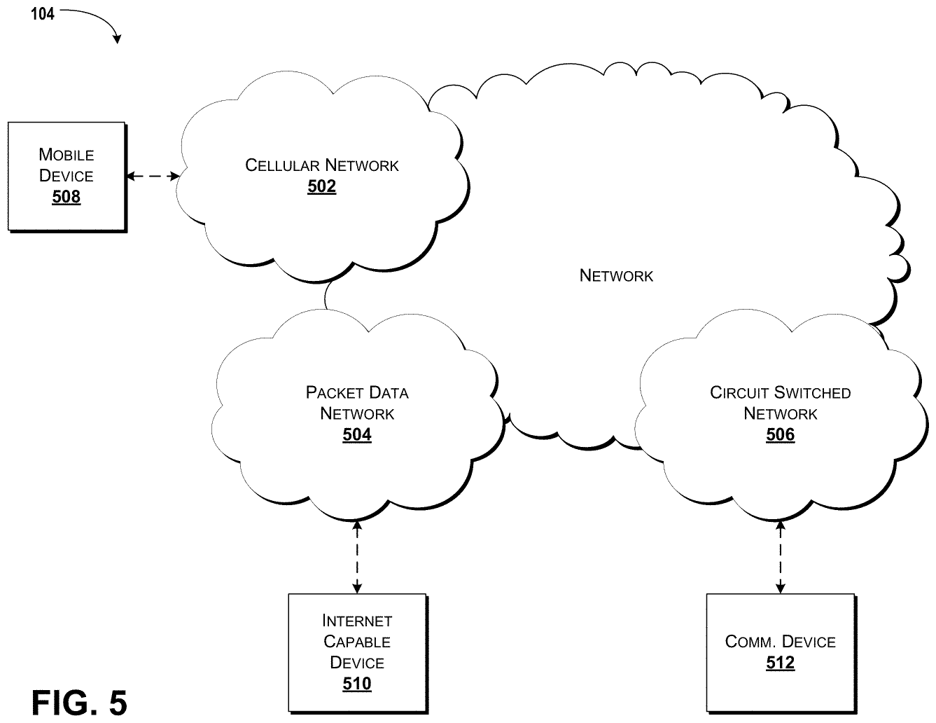

Turning now to FIG. 5, additional details of the network 104 are illustrated, according to an illustrative embodiment. The network 104 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSDPA), and HSPA+. The cellular network 502 also is compatible with 4G mobile communications standards, 5G mobile communications standards, other mobile communications standards, and evolved and future mobile communications standards.

The packet data network 504 includes various devices, for example, servers, computers, databases, and other devices in communication with one another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network 104 is used to refer broadly to any combination of the networks 502, 504, 506. It should be appreciated that substantially all of the functionality described with reference to the network 104 can be performed by the cellular network 502, the packet data network 504, and/or the circuit switched network 506, alone or in combination with other networks, network elements, and the like.

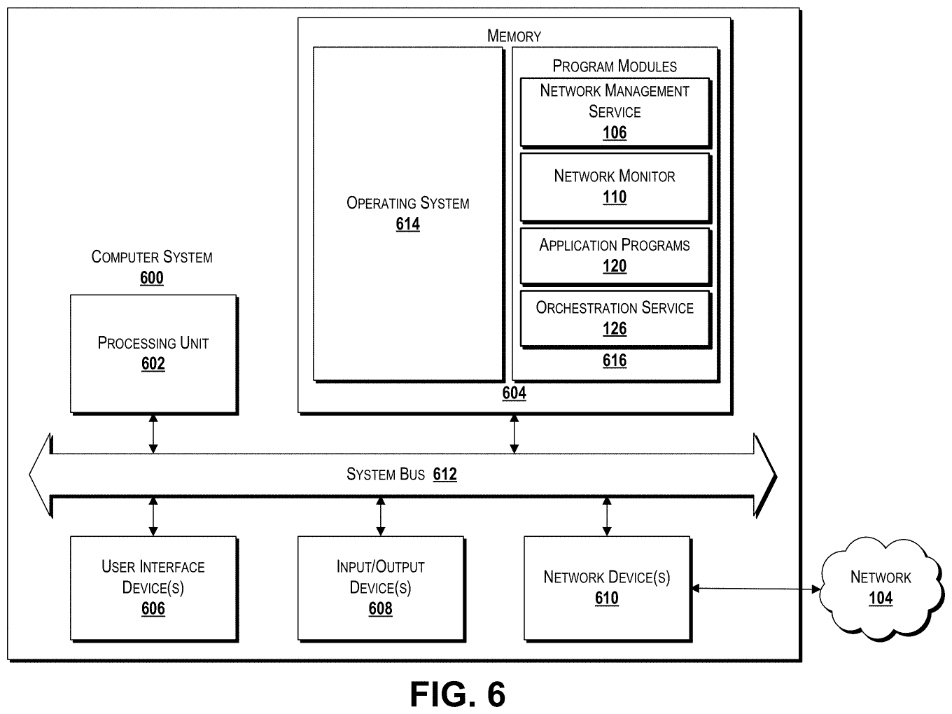

FIG. 6 is a block diagram illustrating a computer system 600 configured to provide the functionality described herein for restoring network configurations using network topology snapshots, in accordance with various embodiments of the concepts and technologies disclosed herein. The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 can include the network management service 106, the network monitor 110, the application programs 120, and/or the orchestration service 126. These and/or other programs can be embodied in computer-readable media containing instructions that, when executed by the processing unit 602, perform one or more of the methods 200 and 300 described in detail above with respect to FIGS. 2-3 and/or other functionality as illustrated and described herein. It can be appreciated that, at least by virtue of the instructions embodying the methods 200 and 300, and/or other functionality illustrated and described herein being stored in the memory 604 and/or accessed and/or executed by the processing unit 602, the computer system 600 is a special-purpose computing system that can facilitate providing the functionality illustrated and described herein. According to embodiments, the program modules 616 may be embodied in hardware, software, firmware, or any combination thereof Although not shown in FIG. 6, it should be understood that the memory 604 also can be configured to store the network topology snapshots 108, the session data 122, the commands 124, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the network 104. Examples of the network devices 610 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

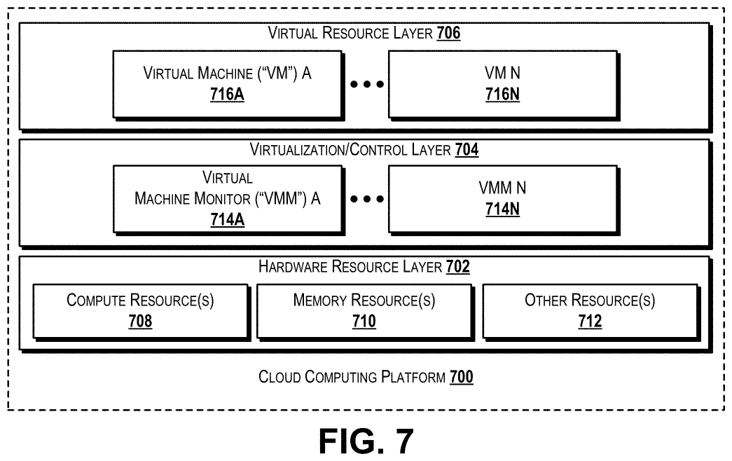

FIG. 7 illustrates an illustrative architecture for a cloud computing platform 700 that can be capable of executing the software components described herein for restoring network configurations using network topology snapshots and/or for interacting with the network management service 106, the network monitor 110, the application programs 120, and/or the orchestration service 126. Thus, it can be appreciated that in some embodiments of the concepts and technologies disclosed herein, the cloud computing platform 700 illustrated in FIG. 7 can be used to provide the functionality described herein with respect to the server computer 102, the network monitor 110, the network environment 112, the computing device 116, and/or the orchestration service 126.

The cloud computing platform 700 thus may be utilized to execute any aspects of the software components presented herein. Thus, according to various embodiments of the concepts and technologies disclosed herein, the network management service 106, the network monitor 110, the application programs 120, and/or the orchestration service 126 can be implemented, at least in part, on or by elements included in the cloud computing platform 700 illustrated and described herein. Those skilled in the art will appreciate that the illustrated cloud computing platform 700 is a simplification of but only one possible implementation of an illustrative cloud computing platform, and as such, the illustrated cloud computing platform 700 should not be construed as being limiting in any way.

In the illustrated embodiment, the cloud computing platform 700 can include a hardware resource layer 702, a virtualization/control layer 704, and a virtual resource layer 706. These layers and/or other layers can be configured to cooperate with each other and/or other elements of a cloud computing platform 700 to perform operations as will be described in detail herein. While connections are shown between some of the components illustrated in FIG. 7, it should be understood that some, none, or all of the components illustrated in FIG. 7 can be configured to interact with one another to carry out various functions described herein. In some embodiments, the components are arranged so as to communicate via one or more networks such as, for example, the network 104 illustrated and described hereinabove (not shown in FIG. 7). Thus, it should be understood that FIG. 7 and the following description are intended to provide a general understanding of a suitable environment in which various aspects of embodiments can be implemented, and should not be construed as being limiting in any way.

The hardware resource layer 702 can provide hardware resources. In the illustrated embodiment, the hardware resources can include one or more compute resources 708, one or more memory resources 710, and one or more other resources 712. The compute resource(s) 708 can include one or more hardware components that can perform computations to process data, and/or to execute computer-executable instructions of one or more application programs, operating systems, services, and/or other software including, but not limited to, the network management service 106, the network monitor 110, the application programs 120, and/or the orchestration service 126 illustrated and described herein.

According to various embodiments, the compute resources 708 can include one or more central processing units (“CPUs”). The CPUs can be configured with one or more processing cores. In some embodiments, the compute resources 708 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 708 can include one or more discrete GPUs. In some other embodiments, the compute resources 708 can include one or more CPU and/or GPU components that can be configured in accordance with a co-processing CPU/GPU computing model. Thus, it can be appreciated that in some embodiments of the compute resources 708, a sequential part of an application can execute on a CPU and a computationally-intensive part of the application can be accelerated by the GPU. It should be understood that this example is illustrative, and therefore should not be construed as being limiting in any way.

In some embodiments, the compute resources 708 also can include one or more system on a chip (“SoC”) components. It should be understood that the SoC component can operate in association with one or more other components as illustrated and described herein, for example, one or more of the memory resources 710 and/or one or more of the other resources 712. In some embodiments in which an SoC component is included, the compute resources 708 can be or can include one or more embodiments of the SNAPDRAGON brand family of SoCs, available from QUALCOMM of San Diego, Calif.; one or more embodiment of the TEGRA brand family of SoCs, available from NVIDIA of Santa Clara, Calif.; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Tex.; one or more customized versions of any of the above SoCs; and/or one or more other brand and/or one or more proprietary SoCs.

The compute resources 708 can be or can include one or more hardware components arranged in accordance with an ARM architecture, available for license from ARM HOLDINGS of Cambridge, United Kingdom. Alternatively, the compute resources 708 can be or can include one or more hardware components arranged in accordance with an x86 architecture, such as an architecture available from INTEL CORPORATION of Mountain View, Calif., and others. Those skilled in the art will appreciate the implementation of the compute resources 708 can utilize various computation architectures and/or processing architectures. As such, the various example embodiments of the compute resources 708 as mentioned hereinabove should not be construed as being limiting in any way. Rather, implementations of embodiments of the concepts and technologies disclosed herein can be implemented using compute resources 708 having any of the particular computation architecture and/or combination of computation architectures mentioned herein as well as other architectures.

Although not separately illustrated in FIG. 7, it should be understood that the compute resources 708 illustrated and described herein can host and/or execute various services, applications, portals, and/or other functionality illustrated and described herein. Thus, the compute resources 708 can host and/or can execute the network management service 106, the network monitor 110, the application programs 120, and/or the orchestration service 126 or other applications or services illustrated and described herein.

The memory resource(s) 710 can include one or more hardware components that can perform or provide storage operations, including temporary and/or permanent storage operations. In some embodiments, the memory resource(s) 710 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 708, subject to the definition of “computer storage media” provided above (e.g., as excluding waves and signals per se and/or communication media as defined in this application).

Although not illustrated in FIG. 7, it should be understood that the memory resources 710 can host or store the various data illustrated and described herein including, but not limited to, the network topology snapshots 108, the session data 122, the commands 124, and/or other data, if desired. It should be understood that this example is illustrative, and therefore should not be construed as being limiting in any way.

The other resource(s) 712 can include any other hardware resources that can be utilized by the compute resources(s) 708 and/or the memory resource(s) 710 to perform operations. The other resource(s) 712 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 702 can be virtualized by one or more virtual machine monitors (“VMMs”) 714A-714N (also known as “hypervisors;” hereinafter “VMMs 714”). The VMMs 714 can operate within the virtualization/control layer 704 to manage one or more virtual resources that can reside in the virtual resource layer 706. The VMMs 714 can be or can include software, firmware, and/or hardware that alone or in combination with other software, firmware, and/or hardware, can manage one or more virtual resources operating within the virtual resource layer 706.

The virtual resources operating within the virtual resource layer 706 can include abstractions of at least a portion of the compute resources 708, the memory resources 710, the other resources 712, or any combination thereof. These abstractions are referred to herein as virtual machines (“VMs”). In the illustrated embodiment, the virtual resource layer 706 includes VMs 716A-716N (hereinafter “VMs 716”).

Based on the foregoing, it should be appreciated that systems and methods for restoring network configurations using network topology snapshots have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
obtaining a first network topology snapshot that describes a first configuration of a network environment at a first point in time,
obtaining a second network topology snapshot that describes a second configuration of the network environment at a second point in time,
calculating a plurality of differences between the first network topology snapshot and the second network topology snapshot,
presenting the plurality of differences for display in a user interface at a computing device, wherein the user interface comprises a visual representation of the plurality of differences, wherein each difference of the plurality of differences is presented with a respective selectable user interface control that is selectable to independently revert an associated difference of the plurality of differences,
in response to determining that a request to restore a previous configuration of an entity in the network environment has been received from the computing device, identifying a configuration change that is to be reverted based on identifying a selected user interface control,
identifying a restore point associated with the configuration change to be reverted, wherein the restore point comprises the first point in time,
generating a command that, when executed by an orchestration service, causes the orchestration service to revert the configuration change for the entity to the previous configuration; and
providing the command to the orchestration service to revert the configuration change.

2. The system of claim 1, wherein a difference of the plurality of differences comprises a change in an ownership of the entity from a first owner to a second owner, and wherein reverting the configuration change comprises changing the ownership of the entity in the network environment from the second owner back to the first owner.

3. The system of claim 1, wherein the first configuration comprises a first attribute for the entity and a further entity having a second attribute, and wherein the second configuration comprises a third attribute for the further entity and another entity having a fourth attribute.

4. The system of claim 1, wherein a difference of the plurality of differences comprises an operating state of the entity in the network environment from a first operating state to a second operating state, and wherein reverting the configuration change comprises changing the operating state of the entity in the network environment from the second operating state back to the first operating state.

5. The system of claim 1, wherein a difference of the plurality of differences comprises an addition of a connection between the entity and a further entity in the network environment, and wherein reverting the configuration change comprises removing the connection between the entity and the further entity.

6. The system of claim 1, wherein a difference of the plurality of differences comprises removal of a connection between the entity and a further entity in the network environment, and wherein reverting the configuration change comprises adding back the connection between the entity and the further entity.

7. The system of claim 1, wherein the configuration change comprises an attribute change applied to the entity, and wherein the entity comprises a physical network function associated with the network environment.

8. A method comprising:
obtaining, at a server computer comprising a processor, a first network topology snapshot that describes a first configuration of a network environment at a first point in time;
obtaining, by the server computer, a second network topology snapshot that describes a second configuration of the network environment at a second point in time;
calculating, by the server computer, a plurality of differences between the first network topology snapshot and the second network topology snapshot;
presenting, by the server computer, the plurality of differences for display in a user interface at a computing device, wherein the user interface comprises a visual representation of the plurality of differences, wherein each difference of the plurality of differences is presented with a respective selectable user interface control that is selectable to independently revert an associated difference of the plurality of differences;
in response to determining that a request to restore a previous configuration of an entity in the network environment has been received from the computing device, identifying, by the server computer, a configuration change that is to be reverted based on identifying a selected user interface control;
identifying, by the server computer, a restore point associated with the configuration change to be reverted, wherein the restore point comprises the first point in time;
generating, by the server computer, a command that, when executed by an orchestration service, causes the orchestration service to revert the configuration change for the entity to the previous configuration; and
providing, by the server computer, the command to the orchestration service to revert the configuration change.

9. The method of claim 8, wherein a difference of the plurality of differences comprises a change in an ownership of the entity from a first owner to a second owner, and wherein reverting the configuration change comprises changing the ownership of the entity in the network environment from the second owner back to the first owner.

10. The method of claim 8, wherein the first configuration comprises a first attribute for the entity and a further entity having a second attribute, and wherein the second configuration comprises a third attribute for the further entity and another entity having a fourth attribute.

11. The method of claim 8, wherein a difference of the plurality of differences comprises an operating state of the entity in the network environment from a first operating state to a second operating state, and wherein reverting the configuration change comprises changing the operating state of the entity in the network environment from the second operating state back to the first operating state.

12. The method of claim 8, wherein a difference of the plurality of differences comprises an addition of a connection between the entity and a further entity in the network environment, and wherein reverting the configuration change comprises removing the connection between the entity and the further entity.

13. The method of claim 8, wherein the configuration change comprises an attribute change applied to the entity, and wherein the entity comprises a physical network function associated with the network environment.

14. A computer storage medium having computer-executable instructions stored thereon that, when executed by a processor, cause the processor to perform operations comprising:
obtaining a first network topology snapshot that describes a first configuration of a network environment at a first point in time;
obtaining a second network topology snapshot that describes a second configuration of the network environment at a second point in time;
calculating a plurality of differences between the first network topology snapshot and the second network topology snapshot;
presenting the plurality of differences for display in a user interface at a computing device, wherein the user interface comprises a visual representation of the plurality of differences, wherein each difference of the plurality of differences is presented with a respective selectable user interface control that is selectable to independently revert an associated difference of the plurality of differences;
in response to determining that a request to restore a previous configuration of an entity in the network environment has been received from the computing device, identifying a configuration change that is to be reverted based on identifying a selected user interface control;
identifying a restore point associated with the configuration change to be reverted, wherein the restore point comprises the first point in time;
generating a command that, when executed by an orchestration service, causes the orchestration service to revert the configuration change for the entity to the previous configuration; and
providing the command to the orchestration service to revert the configuration change.

15. The computer storage medium of claim 14, wherein a difference of the plurality of differences comprises a change in an ownership of the entity from a first owner to a second owner, and wherein reverting the configuration change comprises changing the ownership of the entity in the network environment from the second owner back to the first owner.

16. The computer storage medium of claim 14, wherein the first configuration comprises a first attribute for the entity and a further entity having a second attribute, and wherein the second configuration comprises a third attribute for the further entity and another entity having a fourth attribute.

17. The computer storage medium of claim 14, wherein a difference of the plurality of differences comprises an operating state of the entity in the network environment from a first operating state to a second operating state, and wherein reverting the configuration change comprises changing the operating state of the entity in the network environment from the second operating state back to the first operating state.

18. The computer storage medium of claim 14, wherein a difference of the plurality of differences comprises an addition of a connection between the entity and a further entity in the network environment, and wherein reverting the configuration change comprises removing the connection between the entity and the further entity.

19. The computer storage medium of claim 14, wherein a difference of the plurality of differences comprises removal of a connection between the entity and a further entity in the network environment, and wherein reverting the configuration change comprises adding back the connection between the entity and the further entity.

20. The computer storage medium of claim 14, wherein the first network topology snapshot comprises data describing the entity, time data, attributes associated with the entity, and a connection associated with the entity.
